(19) United States
(12) Patent Application Publication
(10) Pub. No.: US 2009/0192846 A1
(43) Pub. Date: Jul. 30, 2009

(54) METHOD AND APPARATUS FOR WEIGHT AND BALANCE MANAGEMENT IN AIRCRAFT

(75) Inventor: Rolf STEFANI, West River, MD (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/025,879

(22) Filed: Feb. 5, 2008

Related U.S. Application Data
(60) Provisional application No. 61/024,018, filed on Jan. 28, 2008.

(51) Int. Cl. G06Q 10/00

(52) U.S. Cl. 705/7; 705/1

(57) ABSTRACT

A method and apparatus for weight and balance management for aircraft is disclosed. The method may include receiving specific aircraft weight and balance data, the specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information, computing weight and balance information based on the received specific aircraft weight and balance data, wherein if the computed weight and balance information does not meet predetermined parameters, sending a signal to alert a user that the computed weight and balance information does not meet predetermined parameters, and sending computed weight and balance information and specific aircraft weight and balance data to a weight and balance management server for at least one of processing and storage.

### PRIORITY INFORMATION

This non-provisional patent application claims priority from U.S. Provisional Patent Application Ser. No. 61/024,018, filed Jan. 28, 2008, the content of which is incorporated by reference in its entirety.

### BACKGROUND OF THE DISCLOSURE

1. Field of the Disclosure

The disclosure relates to management of weight and balance of cargo on aircraft.

2. Introduction

For cargo airlines, weight and balance of the cargo load can be crucial for safety of flight and fuel cost savings. Airline personnel spend considerable man-hours ensuring that the weight and balance of aircraft meet specific criteria for safety of flight and fuel cost savings, for example.

Conventional weight and balance load planning and performance calculating systems are cumbersome and require considerable time and manual entries. Changes in cargo placement also require manual or cumbersome automated changes in airline paperwork.

### SUMMARY OF THE DISCLOSURE

A method and apparatus for weight and balance management for aircraft is disclosed. The method may include receiving specific aircraft weight and balance data, the specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information, computing weight and balance information based on the received specific aircraft weight and balance data, wherein if the computed weight and balance information does not meet predetermined parameters, sending a signal to alert a user that the computed weight and balance information does not meet predetermined parameters, and sending computed weight and balance information and specific aircraft weight and balance data to a weight and balance management server for at least one of processing and storage.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary weight and balance management system in accordance with a possible embodiment of the disclosure;

FIG. 2 illustrates a block diagram of an exemplary weight and balance management unit in accordance with a possible embodiment of the disclosure;

FIG. 3 illustrates an exemplary weight and balance aircraft diagram for load planning in accordance with a possible embodiment of the disclosure;

FIG. 4 is an exemplary flowchart illustrating one weight and balance management process in accordance with one possible embodiment of the disclosure;

FIG. 5 illustrates an exemplary weight and balance initial interface in accordance with a possible embodiment of the disclosure;

FIG. 6 illustrates an exemplary weight and balance touch screen interface for data entry in accordance with a possible embodiment of the disclosure;

FIG. 7 illustrates an exemplary weight and balance touch screen interface for loading existing weight and balance files in accordance with a possible embodiment of the disclosure;

FIG. 8 illustrates an exemplary weight and balance parameter status and data input interface in accordance with a possible embodiment of the disclosure;

FIG. 9 illustrates an exemplary weight and balance cargo data input interface in accordance with a possible embodiment of the disclosure;

FIG. 10 illustrates an exemplary weight and balance calculation status display in accordance with a possible embodiment of the disclosure;

FIG. 11 illustrates an exemplary airframe data configuration and parameter interface in accordance with a possible embodiment of the disclosure;

FIG. 12 illustrates an exemplary RFID location input interface in accordance with a possible embodiment of the disclosure; and

FIG. 13 illustrates an exemplary RFID container identification interface in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. Note that while this disclosure discusses aircraft, airline and railway travel uses for the disclosure, the disclosure is by no means limited to that area and may be applied to a wide variety of environment and uses.

This disclosure concerns a weight and balance application specifically designed to permit easy input of data as well as for managing distribution of cargo containers and providing a seamless data exchange capability with the customer's conventional weight and balance load planning and performance calculating system. The weight and balance application may be Electronic Flight Bag (EFB) hosted and may be executed on a cost effective tablet personal computer (PC) and can use the data link system to move the entered or acquired weight and balance information to and from where it is needed without requiring redundant data input. The weight and balance application may be focused on easy data input as well as addresses the unique requirements of cargo container placement and special handling parameters required by the users.

The weight and balance application that is disclosed herein describes a “Finger Friendly” user interface for entering the necessary data which addresses the specific needs of a specific Cargo airline with regard to container default weights, locations and parameters that are used by the airline operationally. This data and user interface can be changed easily. The weight and balance application may use bar code scanning or Radio Frequency Identification (RFID) technology as well as interfaces to existing weight measuring devices to automatically input cargo container identification and associated weights.

The weight and balance application may include a user interface that was easy to understand and use as well as to use a database for individual tail numbers that allowed flexibility in defining specific airframe characteristics. The database architecture may be XML-based, for example, in order to allow easy portability of the data as well as to allow for management of the data components that reside on the EFB and for the data that is communicated.

As an aircraft chooses to perform weight and balance and performance calculations, for example, the weight and balance may transmit the weight and balance data to their dispatch system in order to do the final calculations. The communications medium may include ACARS and ground based 802.11× technologies. Conceptually, ACARS may be used at remote sites and while in-flight and 802.11 may be suitable for use at the master cargo sort facility where all aircraft ultimately converge in a confined area. Weight and balance data may be received packaged in ACARS messages and extracted from the application and passed to a processing system or server via an automated data interface, for example.

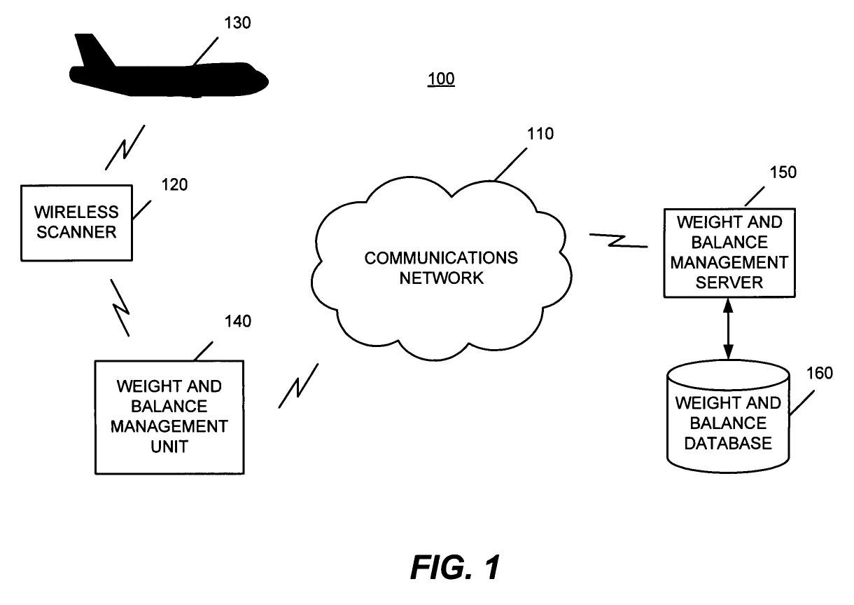

FIG. 1 illustrates an exemplary weight and balance management system 100 in accordance with a possible embodiment of the disclosure. The weight and balance management system 100 may include one or more wireless scanners 120, one or more aircraft 130, a weight and balance management unit 140, a weight and balance management server 150, and a weight and balance database. The weight and balance management unit 140 and weight and balance management server 150 may communicate through the communications network 110. Although the connections in FIG. 1 are shown as wireless configuration, one or more of these connections may be wired.

The one or more wireless scanner 120 may represent any scanner used to scan for identification devices (e.g., barcodes, RFID tags, etc.) found in, on or around containers, cargo, and locations on the aircraft, such as an RFID or bar code scanner.

The one or more aircraft 130 represents any aircraft that transports cargo, including passenger airlines, cargo airlines, charter airlines, private jets, etc.

The weight and balance management server 150 may be any server, computer or other similar device capable of storing and managing media publications and other documents and products. Weight and balance management database 160 may serve to store weight and balance data and aircraft configurations for individual flights, aircraft, and/or aircraft type, for example.

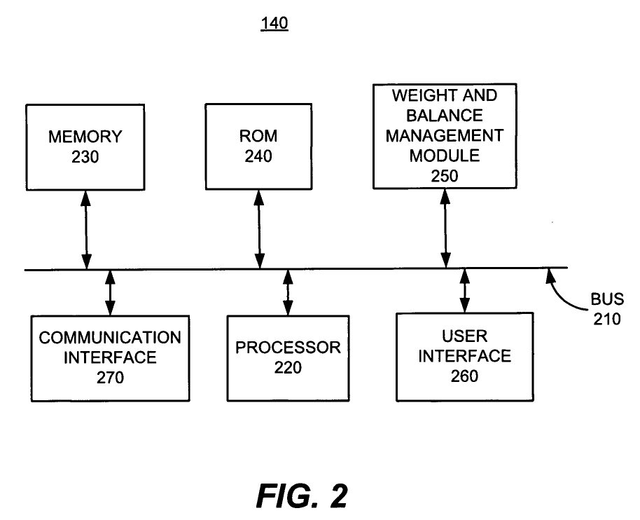

FIG. 2 illustrates a block diagram of an exemplary a weight and balance management unit 140 in accordance with a possible embodiment of the disclosure. The a weight and balance management unit 140 may include a bus 210, a processor 220, a memory 230, a read only memory (ROM 240, a weight and balance management module 250, a user interface 260, and a communication interface 270. The bus 210 may permit communication among the components of the weight and balance management unit 140.

The processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

The communication interface 270 may include any mechanism that facilitates communication via the communications network 110. For example, the communication interface 270 may include a modem. Alternatively, the communication interface 270 may include other mechanisms for assisting in communications with other devices and/or systems.

ROM 240 may include a conventional ROM device or another type of static storage device that stores static information and instructions for the processor 220. The weight and balance management unit 140 may also include any type of storage media, such as, for example, magnetic or optical recording media and its corresponding drive.

The user interface 260 may include one or more conventional input mechanisms that permit a user to input information, communicate with the weight and balance management unit 140, and/or present information to the user, such as an electronic display, microphone, touchpad, keypad, keyboard, mouse, pen, stylus, voice recognition device, buttons, one or more speakers, etc. Output mechanisms for the user interface 260 may include one or more conventional mechanisms that output information to the user, including a display, a printer, one or more speakers, or a medium, such as a memory, or a magnetic or optical disk and a corresponding disk drive.

The weight and balance management unit 140 may perform such functions in response to the processor 220 by executing sequences of instructions contained in a computer-readable medium, such as, for example, memory 230. Such instructions may be read into memory 230 from another computer-readable medium, such as a storage device or from a separate device via the communication interface 270.

The weight and balance management unit 140 illustrated in FIGS. 1 and 2 and the related discussion are intended to provide a brief, general description of a suitable communication and processing environment in which the disclosure may be implemented. Although not required, the disclosure will be described, at least in part, in the general context of computer-executable instructions, such as program modules, being executed by the weight and balance management unit 140, such as a communication server, communications switch, communications router, or general purpose computer, for example. Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

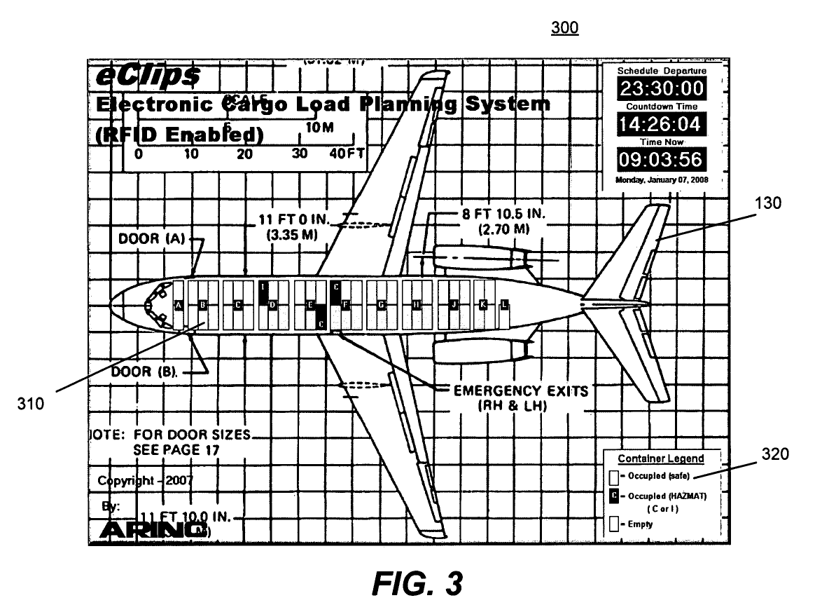

FIG. 3 illustrates an exemplary weight and balance aircraft diagram 300 for load planning in accordance with a possible embodiment of the disclosure. The exemplary diagram 300 shows an aircraft 130 and the various cargo and or container storage areas 310. The storage areas 310 may be identified by alphanumeric identifications, for example. The storage areas 310 may be coded according to the legend 320 as being empty, occupied, and or occupied with hazardous materials, for example.

Note that the diagram 300 in FIG. 3 is merely exemplary. Other diagrams showing the aircraft's configuration may be used. This diagram 300 may be used for load planning, load calculation, cargo identification, and/or historical data.

For illustrative purposes, the operation of the weight and balance management unit 140 will be described below in relation to the diagrams shown in FIGS. 1-3.

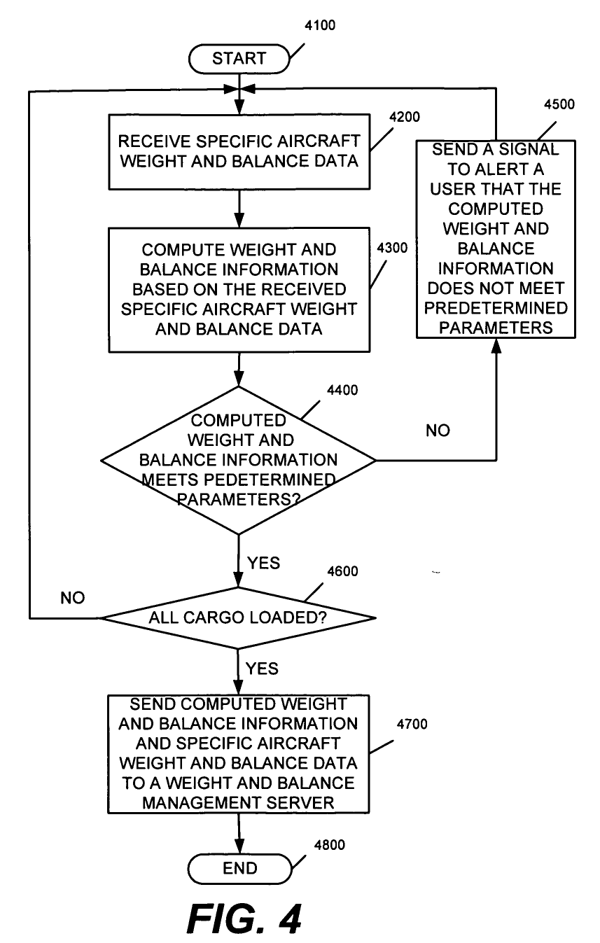

FIG. 4 is an exemplary flowchart illustrating one possible weight and balance management process in accordance with one possible embodiment of the disclosure. The process begins at step 4100 and continues to step 4200 where the weight and balance management module 250 may receive specific aircraft weight and balance data. The specific aircraft weight and balance data may include aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information.

The specific aircraft weight and balance data may be received by at least one of manual entry and automatically. As far as automatically receiving data, the specific aircraft weight and balance data may be received from a memory, a server, a scanner, and a Radio Frequency Identification (RFID) device, for example.

At step 4300, the weight and balance management module 250 may compute weight and balance information based on the received specific aircraft weight and balance data. At step 4400, the weight and balance management module 250 may determine if the computed weight and balance information meets predetermined parameters. The predetermined parameters may be weight differentials between different sections of the aircraft and weight limits, for example.

If the weight and balance management module 250 determines that the computed weight and balance information does not meet predetermined parameters, the process goes to step 4500 where the weight and balance management module 250 may send a signal to alert a user that the computed weight and balance information does not meet predetermined parameters. The weight and balance management module 250 may also make suggestions on how to solve the weight and balance problem, such as moving containers and or cargo to different locations. The process then returns back to step 4200 where the weight and balance management module 250 may receive updated information and recomputed the weigh and balance information.

If at step 4400, the weight and balance management module 250 determines that the computed weight and balance information meets the predetermined parameters, at step 4600, the weight and balance management module 250 may determine if there is any more cargo to be loaded. If the weight and balance management module 250 determines that there is more cargo to be loaded, the process returns to step 4200.

If the weight and balance management module 250 determines that there is no more cargo to be loaded, the process goes to step 4700 where the weight and balance management module 250 may send the computed weight and balance information and specific aircraft weight and balance data to a weight and balance management server for at least one of processing and storage. The computed weight and balance information and specific aircraft weight and balance data may be sent using Aircraft Communication Addressing and Reporting System (ACARS). The process then goes to step 4800 and ends.

The aircraft identification information may include aircraft tail number, aircraft configuration, aircraft empty weight, flight information, aircraft flight parameters, aircraft weight and balance limits, and safety of flight information, for example. The container identification information may include identification number, content information, hazardous material information, destination information, and origin information, for example. Fuel information may include fuel, location, fuel type, fuel amount, and fuel weight, for example.

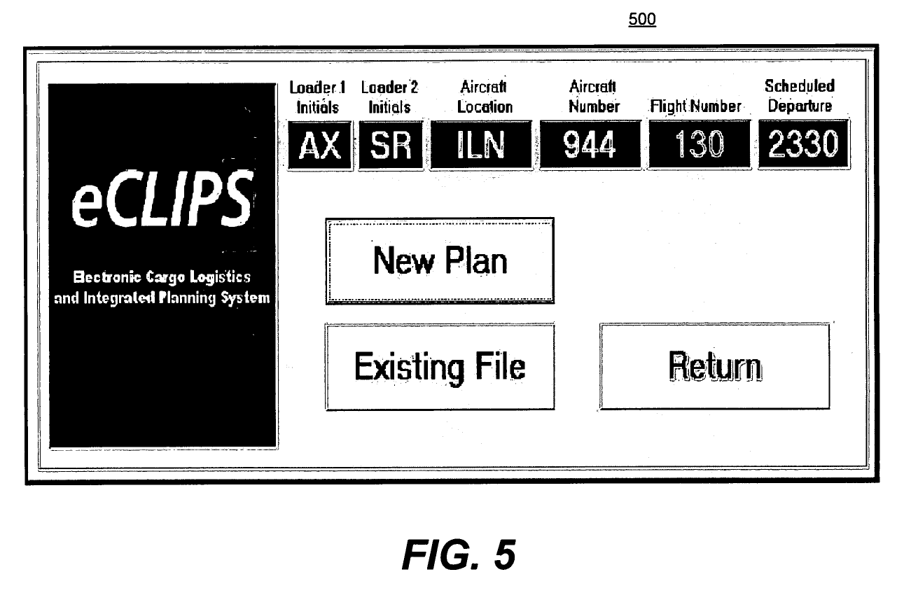

FIGS. 5-13 show various exemplary interfaces that maybe used in the load planning and weight and balance management process. FIG. 5 illustrates an exemplary weight and balance initial interface for in accordance with a possible embodiment of the disclosure. When the weight and balance process is started, the user has an opportunity to set certain parameters which may be used by the application for various purposes, such as identifying the specific aircraft tail number and the actual current location airport for the flight. In this example, the user may enter the loaders' initials, the aircraft location, the aircraft number, the flight number, and the scheduled departure time. The scheduled departure time may be important as there may be a departure countdown alerting capability included in the process and interface.

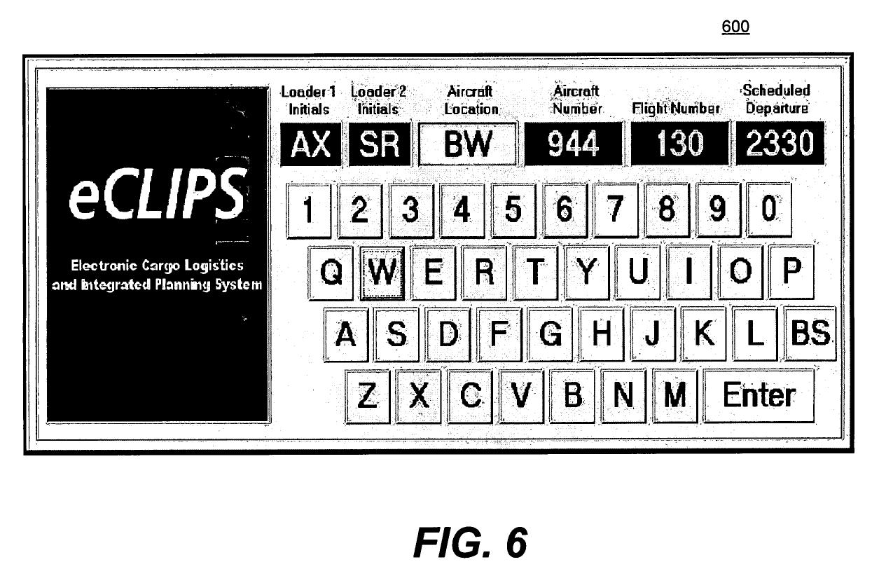

FIG. 6 illustrates an exemplary weight and balance touch screen interface for data entry in accordance with a possible embodiment of the disclosure. When the user touches one of the six (6) available data fields, a finger friendly keyboard may be presented which allows the user to enter new data in the selected field. The example in FIG. 6 shows that the current location airport is in the process of being changed from ILN to BWI.

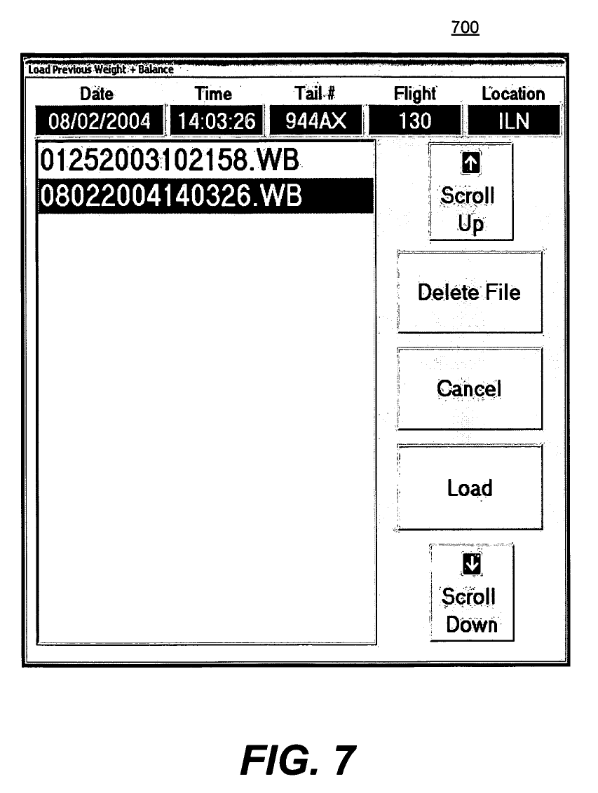

FIG. 7 illustrates an exemplary weight and balance touch screen interface for loading existing weight and balance files in accordance with a possible embodiment of the disclosure. If the “Existing File” button was depressed on the main log on screen in FIG. 5, a list of existing weight and balance files may be presented to the user for selection. Note that the listed file names may include time and date information. For example, the highlighted file name above shows that the file was created on Aug. 2, 2004 at 14:03:26. This allows the user to return to a weight and balance plan that he or she had previously started. The process may also allow the user to specify the specific tail number because each airframe has a unique configuration and weight and balance parameter file associated to it.

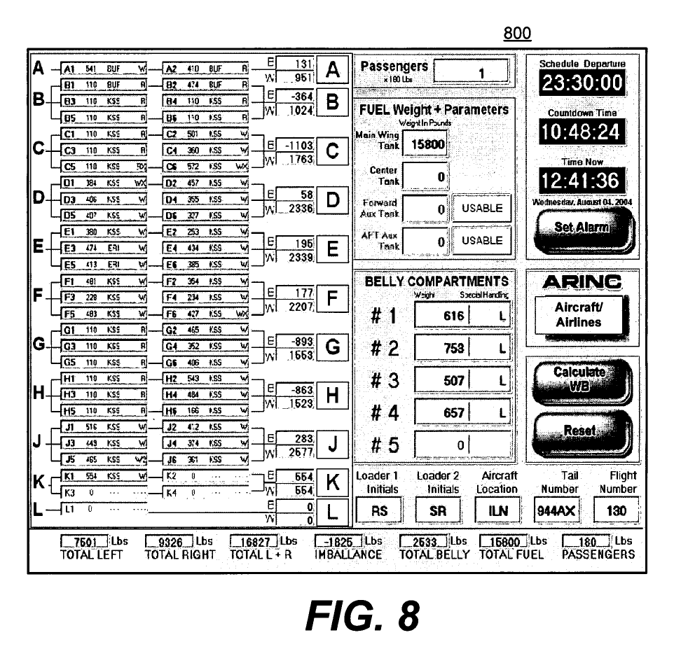

FIG. 8 illustrates an exemplary weight and balance data input interface in accordance with a possible embodiment of the disclosure. Data may be entered on this form automatically or manually. The 2 main columns on the left side of the screen may represent the physical location for each cargo container that will be loaded on the aircraft. This table may be referred to as the “Cargo Distribution Table”. These data fields contain the location code in the aircraft (i.e. A1), a space for the actual container weight, destination (3 characters) and an aggregate of up to 4 parameters (individual character codes) that are used to indicate specific items, such as hazardous cargo, delivery instructions, and type of container.

For example, in a DC-9, each of the field areas (A-L) may represent one of the 11 cargo areas of the aircraft where “A” is located at the front and “L” is towards the Tail section. As data is input, a running total of the Balance may be shown in the “B” box to the right and the Weight is shown in the “W” box. These totals are for the specific lateral location (A-L). Note that this table will differ for different aircraft configurations.

To enter data in a specific field, the user may either touch the exact field where the container is being placed or the user may touch one of the larger, light blue “A” to “L” buttons to the right of the load diagram which will pop up a larger view of the load row enabling easier selection.

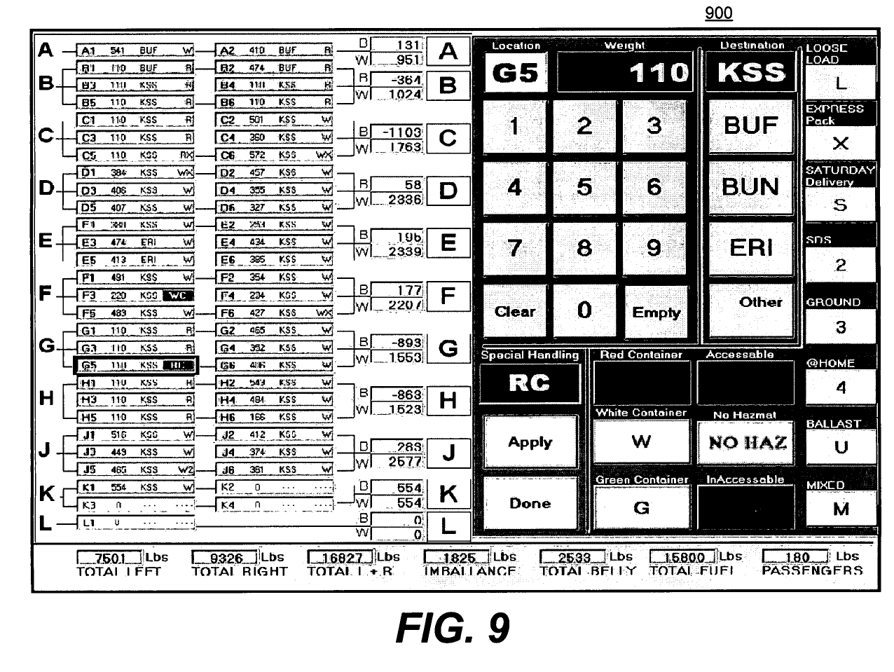

FIG. 9 illustrates an exemplary weight and balance cargo data input interface in accordance with a possible embodiment of the disclosure. Once a specific container location has been identified by touching it, a pop up window may appear on the right side of the screen (highlighted with red border) which provides an easy way to enter all necessary parameters concerning that container that will be placed in the specific aircraft location. In this example, the location “G5” is highlighted in the cargo distribution table as well as in the data entry template in the Location field.

Note that if data has already been entered in the table, the pop-up template may reflect all current values and parameters allowing easy correction of any field with a simple touch, for example. There may be color coding to indicate in the cargo distribution table field that the Hazardous material attribute or parameter was set when entering the data. This identification may be a requirement for the actual print out of the cargo report/load plan.

The Container color which may be a company-specific code for type of container may be an important attribute because it associates the empty container weight with the actual weight of the contents in order to determine the actual revenue generating weight of the cargo.

Data entry fields are also available for several other flight specific parameters including; number of people on board, weight and distribution of fuel in specific tanks, and the distribution and special handling parameters of cargo in the belly compartments of the aircraft. As is available in the airframe cargo data fields, Special Handling parameters can be entered as well for the belly compartment cargo and this data is displayed in the right side of the data field.

The passenger weight may be taken from a modifiable parameter field in the airframe data set. This allows for changing the default weight per person depending on season or other factors. In this embodiment, if the user touches a specific field, a context sensitive data entry template is presented to the user in order for input of the necessary values. In this example, the “Belly #1” field was touched. The “Remove” button may be pressed on the template to effectively indicate that there is no cargo in the specified location and remove the template from view. The “Done” button may be pressed to transfer the data from the template into the appropriate data field and close the template pop up.

A similar template appears for “Belly Compartments” as well as for the “Passengers” field. Current information about this specific weight and balance session may be shown as highlighted areas. For example, if the upper right side was highlighted, this would identify the loaders by initials, the location of the aircraft, and the tail and flight number. The lower area if highlighted may show 7 data fields that are continually updated programmatically as data is entered in the data entry fields previously described.

As the user requires access to other forms and capabilities, several button commands may be available that when touched, will navigate the application as desired. The main form provides 4 additional features. Besides the main form primary function of providing a clean method of entering required data, the form also provides access to additional capabilities which may include:

| Command | Result: |
|---|---|
| Set Alarm | Shows form to set Departure Time and set Alarms On/Off. |
| Aircraft/ | Pressed to show Airframe data configuration and |
| Airline | Parameter form. |
| Calculate | Performs the W&B Calculations and displays the W&B report |
| W&B | page/form |
| Reset | Allowing the user to return to the initial log on screen |
| | to either start a new/blank W&B session, load another |
| | existing W&B data set, change some trip parameters |
| | or return to this main screen with no action taken. |

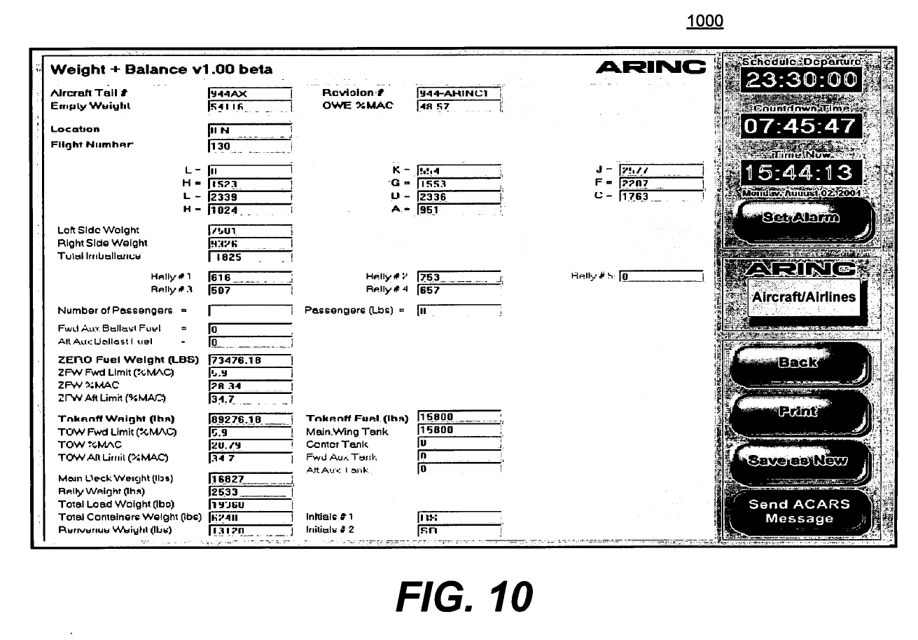

FIG. 10 illustrates an exemplary weight and balance calculation interface in accordance with a possible embodiment of the disclosure. This interface displays the calculated weight and balance data and provides a clear synopsis to the user. Note that weight distribution is calculated both longitudinally as well as laterally. The interface may also provides some additional capabilities which include:

| Command | Result: |
|---|---|
| Set Alarm | Shows form to set Departure Time and set Alarms On/Off. |
| Aircraft/ | Pressed to show Airframe data configuration and |
| Airlines | Parameter form. |
| Back | Returns display to primary data input form. |
| Print | Allowing the user to “PRINT” the W&B data |
| | if a printer is configured. |
| Save | Saves the current W&B data using date and time |
| As New | of the save. |
| Send | Packages the W&B data into an ACARS message and |
| ACARS | forwards (via API) to the integrated ACARS |
| Message | software & avionics for transmission. |

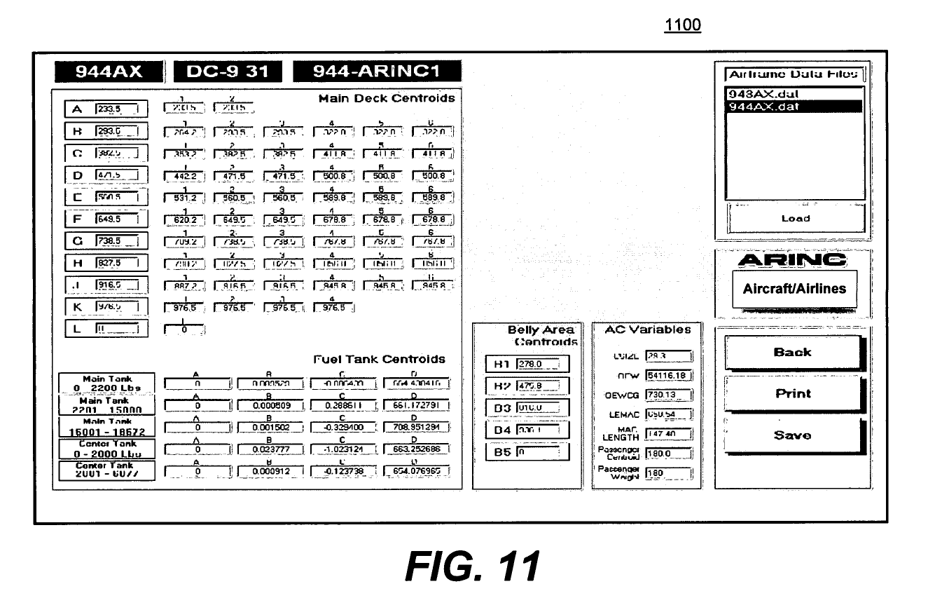

FIG. 11 illustrates an exemplary airframe data configuration and parameter interface in accordance with a possible embodiment of the disclosure. The airframe data configuration and parameter interface is accessed at any time in the weight and balance process by simply touching the Airline/Aircraft button on the right center of all screens.

This interface is used to manage and configure parameters for the specific airframe. Certain data fields are editable and other data fields are calculated data derived from the parameters to the far left.

The interface also provides some additional capabilities which include:

| Command | Result: |
|---|---|
| Load | If a different tail number data set is identified in |
| | the list, the Load button is enable and pressing |
| | the Load will then load the airframe |
| | parameters to the interface. |
| Aircraft/ | Not active in this interface |
| Airlines | |
| Back | Returns display to previously displayed form/window. |
| Print | Allows the user to “PRINT” the Configuration |
| | data if a printer is configured. |
| Save | If any data is changed on this interface, the button becomes |
| | enabled and when pressed, the existing configuration file is |
| | overwritten with the current content of all fields. |

Another feature of the weight and balance process may include an integrated countdown to departure timer with an alarm capability. To assist and advise loading crew of time remaining until the scheduled (or input time parameter) departure time, a real-time display of current time and departure time may be constantly shown in the upper right corner of the display. When the current time is within a specified time of the departure, an audible alert may be generated and the countdown time may begin to flash. The audible alert and flashing time may be acknowledged by simply touching the flashing time, for example. The “Set Alarm” command button may be touched to cause the clock entry window to pop up which enables the user to set the departure time, set the time before departure alert interval and to turn alarm functionality on or off, for example. The “Done” may be pressed to dispose of the pop up window and return the display to the previous view, for example.

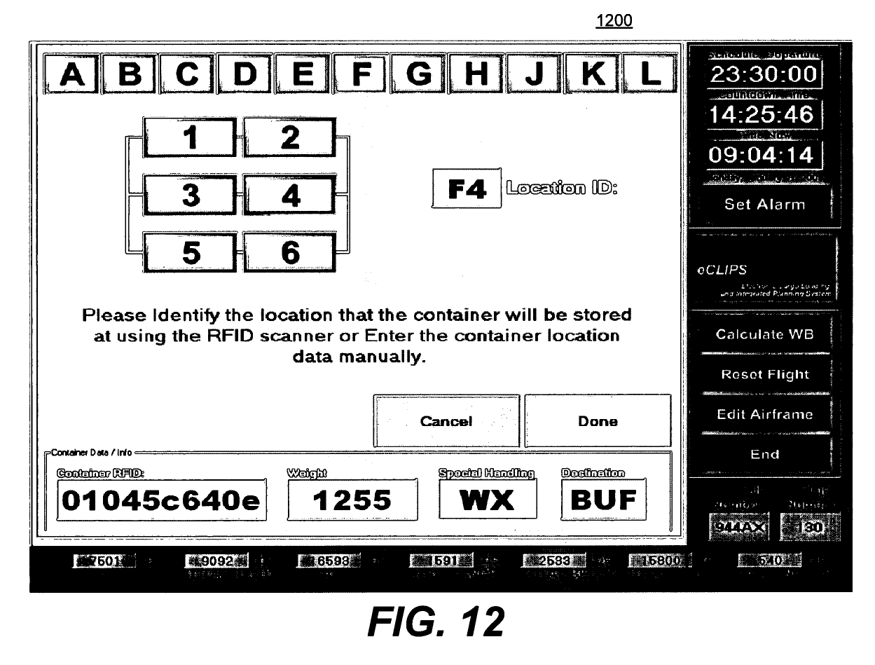

FIG. 12 illustrates an exemplary RFID location input interface in accordance with a possible embodiment of the disclosure. In order to demonstrate the potential to significantly reduce the manual input requirements, an automated RFID capability may be included to provide for RFID assisted identification of containers and actual aircraft locations of containers using 802.11 connected RFID handheld devices or bar code scanner, for example. In this manner, the user may simply display a dynamic interface of the airframe such as that shown in FIG. 3 which shows color codes and icons depicting the real-time status of the container parameters and locations (depicted below). Note that the departure timer function is displayed as well.

The RFID input capability may be designed to compliment the manual entry of container data as well as specific location information. If a location specific RFID tag is scanned using a handheld RFID scanning device, a location template may be displayed to the user on both tablet PC device and the handheld device. The user may complete the input of the container location by touching the “Done” button or the handheld trigger. The user may also change the location dynamically using the input panel (manually) to by simply scanning another location RFID tag.

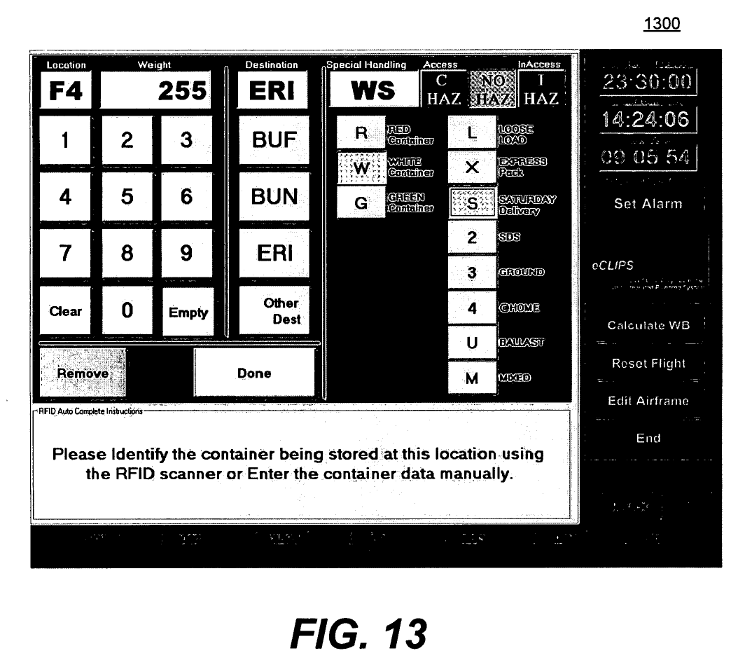

FIG. 13 illustrates an exemplary RFID container identification interface in accordance with a possible embodiment of the disclosure. If a container specific RFID tag is scanned using a handheld RFID scanning device, a container template may be displayed to the user on both tablet PC device and the handheld device. The user may complete the input of the container specifics by touching the “Done” button or the handheld trigger. The user may also change the container specifics dynamically using the input panel (manually) to by simply scanning another container identification RFID tag.

The capabilities described in this disclosure have been presented using very specific examples of providing a communications enabled weight and balance process that fulfills specific requirements. It is important to realize that a process may be developed to leverage other customers communications infrastructures, databases and specific work flow and procedures to exploit RFID capabilities.

While this disclosure describes an ACARS connected EFB implementation, it should be easy to conceive that there could be other permutations developed that would fully integrate to tablet PC type of situations or even to host processing type of scenarios. Any apparatus may be used as long as the ability to capture container and location data as easily as possible and draw from a database to extract the necessary parameter data remains.

Note that the actual container specifics (data) may be automatically displayed to the user. The user may then change any data field manually using the touch input on the display.

In addition to the weight and balance application described herein, the related process of intelligent load distribution and planning capability that would interactively calculate the optimum distribution of cargo containers (given that their weights are known) and suggest to loaders their loading sequence and actual best locations may also be described. This additional capability would result in optimum cargo loading and result in savings to the customer.

The load planning process may include receiving specific aircraft weight and balance data. The specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information.

The load planning process may also include creating a load plan to determine positions of cargo and containers based on the received specific aircraft weight and balance data. If the created load plan does not meet predetermined parameters, the process may send a signal to alert a user that created load plan does not meet predetermined parameters and suggest load planning solutions. The load planning process may output the created load plan and specific aircraft weight and balance data to a user.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosure, rather than any specific examples given.

What is claimed is:

1. A method for weight and balance management for aircraft, comprising:
receiving specific aircraft weight and balance data, the specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information;
computing weight and balance information based on the received specific aircraft weight and balance data, wherein if the computed weight and balance information does not meet predetermined parameters, sending a signal to alert a user that the computed weight and balance information does not meet predetermined parameters; and
sending computed weight and balance information and specific aircraft weight and balance data to a weight and balance management server for at least one of processing and storage.

2. The method of claim 1, wherein the aircraft identification information includes at least one of aircraft tail number, aircraft configuration, aircraft empty weight, flight information, aircraft flight parameters, aircraft weight and balance limits, and safety of flight information.

3. The method of claim 1, wherein the container identification information includes at least one of identification number, content information, hazardous material information, destination information, and origin information.

4. The method of claim 1, wherein the specific aircraft weight and balance data is received by at least one of manual entry and automatically.

5. The method of claim 1, wherein the specific aircraft weight and balance data is received from at least one of a memory, a server, a bar code scanner, and a Radio Frequency Identification (RFID) device.

6. The method of claim 1, wherein the predetermined parameters are at least one of weight differentials between different sections of the aircraft and weight limits.

7. The method of claim 1, wherein fuel information is at least one of fuel, location, fuel type, fuel amount, and fuel weight.

8. The method of claim 1, wherein the computed weight and balance information and specific aircraft weight and balance data is sent using Aircraft Communication Addressing and Reporting System (ACARS).

9. The method of claim 1, wherein if the computed weight and balance information does not meet predetermined parameters, the method further comprises:
suggesting a solution to solve a weigh and balance problem.

10. The method of claim 9, wherein the suggested solution includes at least one of suggesting containers to move and suggesting cargo to move.

11. An apparatus for weight and balance management for aircraft, comprising:
a communication interface; and
a weight and balance management module that receives specific aircraft weight and balance data, the specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information, computes weight and balance information based on the received specific aircraft weight and balance data, wherein if the computed weight and balance information does not meet predetermined parameters, the weight and balance management module sends a signal to alert a user that the computed weight and balance information does not meet predetermined parameters, and sends computed weight and balance information and specific aircraft weight and balance data using the communication interface to a weight and balance management server for at least one of processing and storage.

12. The apparatus of claim 11, wherein the aircraft identification information includes at least one of aircraft tail number, aircraft configuration, aircraft empty weight, flight information, aircraft flight parameters, aircraft weight and balance limits, and safety of flight information.

13. The apparatus of claim 11, wherein the container identification information includes at least one of identification number, content information, hazardous material information, destination information, and origin information.

14. The apparatus of claim 11, wherein the weight and balance management module receives the specific aircraft weight and balance data by at least one of manual entry and automatically.

15. The apparatus of claim 11, wherein the weight and balance management module receives specific aircraft weight and balance data from at least one of a memory, a server, a bar code scanner, and a Radio Frequency Identification (RFID) device.

16. The apparatus of claim 11, wherein the predetermined parameters are at least one of weight differentials between different sections of the aircraft and weight limits.

17. The apparatus of claim 11, wherein fuel information is at least one of fuel, location, fuel type, fuel amount, and fuel weight.

18. The apparatus of claim 11, wherein the weight and balance management module sends the computed weight and balance information and specific aircraft weight and balance data using Aircraft Communication Addressing and Reporting System (ACARS).

19. The apparatus of claim 11, wherein if the computed weight and balance information does not meet predetermined parameters, the weight and balance management module suggests a solution to solve a weigh and balance problem.

20. The apparatus of claim 19, wherein the suggested solution includes at least one of suggesting containers to move to another location and suggesting cargo to move to another location.

21. A method for load planning for cargo to be loaded on an aircraft, comprising:
receiving specific aircraft weight and balance data, the specific aircraft weight and balance data including aircraft identification information, passenger and crew information, aircraft destination information, container and cargo destination information, cargo and container origin information, fuel information, container identification information, container weight information, cargo weight information, cargo storage area identification information, cargo storage area configuration information, and container storage area configuration information;
creating a load plan to determine positions of cargo and containers based on the received specific aircraft weight and balance data, wherein if the created load plan does not meet predetermined parameters, sending a signal to alert a user that created load plan does not meet predetermined parameters; and
outputting the created load plan and specific aircraft weight and balance data to a user.
